(19) United States
(12) Patent Application Publication
(10) Pub. No.: US 2013/0326090 A1
(43) Pub. Date: Dec. 5, 2013

(54) RING TOPOLOGY STATUS INDICATION

(71) Applicant: MOSAID TECHNOLOGIES INCORPORATED, Ottawa (CA)

(72) Inventor: Peter GILLINGHAM, Ottawa (CA)

(73) Assignee: MOSAID TECHNOLOGIES INCORPORATED, Ottawa (CA)

(21) Appl. No.: 13/903,418

(22) Filed: May 28, 2013

Related U.S. Application Data
(60) Provisional application No. 61/652,513, filed on May 29, 2012.

(51) Int. Cl. G06F 11/30; G06F 3/06

(52) U.S. Cl. CPC G06F 11/3065; G06F 3/0688
USPC 710/5; 710/19

(57) ABSTRACT

A semiconductor device includes a bridging device having an external data interface, an external status interface, and a plurality of internal data interfaces. A plurality of memory devices are each connected to the bridging device via one of the internal data interfaces. Each of the memory devices has a ready/busy output connected to an input of the bridging device. The bridging device is configured to output a current state of each ready/busy output in a packetized format on the external status interface in response to a status request command received on the external status interface; and read information from a status register of a selected memory device over one of the internal data interfaces and provide the information on the external data interface in response to a status read command received on the external data interface. A method of operating a semiconductor device is also disclosed.

### CROSS REFERENCE TO RELATED APPLICATIONS

This application claims priority to U.S. Provisional Patent Application Ser. No. 61/652,513, filed May 29, 2012, the contents of which are hereby incorporated by reference in their entirety.

### FIELD OF THE INVENTION

The invention relates generally to an apparatus and method for communicating status information from multiple serially-connected semiconductor devices to a controller.

### BACKGROUND

Computers and other information technology systems typically contain semiconductor devices such as memory. The semiconductor devices are controlled by a controller, which may form part of the central processing unit (CPU) of a computer or may be separate therefrom. The controller has an interface for communicating information to and from the semiconductor devices. Also, it will be understood that the types of information that might be communicated, and the various implementations disclosed in the prior art for carrying out such controller-device communications, are numerous. Ready or busy status of the memory device is an example of just one type of information that might be communicated from a memory device to a controller.

Examples of memory systems having ring topologies are described in U.S. Patent Application Publication No. 2008/0201548 entitled “SYSTEM HAVING ONE OR MORE MEMORY DEVICES” which was published on Aug. 21, 2008, U.S. Patent Application Publication No. 2008/0049505 entitled “SCALABLE MEMORY SYSTEM” which was published on Feb. 28, 2008, U.S. Patent Application Publication No. 2008/0052449 entitled “MODULAR COMMAND STRUCTURE FOR MEMORY AND MEMORY SYSTEM” which was published on Feb. 28, 2008, U.S. Patent Application Publication No. 2010/0091536 entitled “COMPOSITE MEMORY HAVING A BRIDGING DEVICE FOR CONNECTING DISCRETE MEMORY DEVICES TO A SYSTEM” which was published on Apr. 15, 2010, all of which are incorporated by reference herein in their entirety. At various points in the description that follows, references may be made to certain example command, address and data formats, protocols, internal device structures, and/or bus transactions, etc., and those skilled in the art will appreciate that further example details can be quickly obtained with reference to the above-mentioned patent references.

In a memory system having a ring topology, command packets originate from a controller and are passed around a ring of memory devices, through each memory device in a point-to-point fashion, until they end up back at the controller. FIG. 1A is a block diagram of an example system that receives a parallel clock signal while FIG. 1B is a block diagram of the same system of FIG. 1A receiving a source synchronous clock signal. The clock signal can be either a single ended clock signal or a differential clock pair.

In FIG. 1A, the system 20 includes a memory controller 22 having at least one output port Xout and an input port Xin, and memory devices 24, 26, 28 and 30 that are connected in series. While not shown in FIG. 1A, each memory device has an Xin input port and an Xout output port. Input and output ports consist of one or more physical pins or connections interfacing the memory device to the system it is a part of In some instances, the memory devices are flash memory devices. The current example of FIG. 1A includes four memory devices, but alternate examples can include a single memory device, or any suitable number of memory devices. Accordingly, if memory device 24 is the first device of the system 20 as it is connected to Xout, then memory device 30 is the Nth or last device as it is connected to Xin, where N is an integer number greater than zero. Memory devices 26 to 28 are then intervening serially connected memory devices between the first and last memory devices. Each memory device can assume a distinct identification (ID) number, or device address (DA) upon power up initialization of the system, so that the memory devices are individually addressable. Commonly owned U.S. Patent Application Publication No. 2008/0155179 titled “APPARATUS AND METHOD FOR PRODUCING IDS FOR INTERCONNECTED DEVICES OF MIXED TYPE”, U.S. Patent Application Publication No. 2007/0233917 titled “APPARATUS AND METHOD FOR ESTABLISHING DEVICE IDENTIFIERS FOR SERIALLY INTERCONNECTED DEVICES”, U.S. Patent Application Publication No. 2008/0181214 titled “APPARATUS AND METHOD FOR PRODUCING DEVICE IDENTIFIERS FOR SERIALLY INTERCONNECTED DEVICES OF MIXED TYPE”, U.S. Patent Application Publication No. 2008/0192649 titled “APPARATUS AND METHOD FOR PRODUCING IDENTIFIERS REGARDLESS OF MIXED DEVICE TYPE IN A SERIAL INTERCONNECTION”, U.S. Patent Application Publication No. 2008/0215778 titled “APPARATUS AND METHOD FOR IDENTIFYING DEVICE TYPE OF SERIALLY INTERCONNECTED DEVICES”, U.S. Patent Application Publication No. 2008/0140899 titled “ADDRESS ASSIGNMENT AND TYPE RECOGNITION OF SERIALLY INTERCONNECTED MEMORY DEVICES OF MIXED TYPE” and U.S. Patent Application Publication No. 2008/0140916 titled “SYSTEM AND METHOD OF OPERATING MEMORY DEVICES OF MIXED TYPE”, all of which are incorporated by reference herein in their entirety, describe methods for generating and assigning device addresses for serially connected memory devices of a system.

Memory devices 24 to 30 are considered serially connected because the data input of one memory device is connected to the data output of a previous memory device, thereby forming a series-connection system organization, with the exception of the first and last memory devices in the chain. The channel of memory controller 22 includes data, address, and control information provided by separate pins, or the same pins, connected to conductive lines. The example of FIG. 1A includes one channel, where the one channel includes Xout and corresponding Xin ports. However, memory controller 22 can include any suitable number of channels for accommodating separate memory device chains. In the example of FIG. 1A, the memory controller 22 provides a clock signal CK, which is connected in parallel to all the memory devices.

In general operation, the memory controller 22 issues a command through its Xout port, which includes an operation code (op code), a device address, optional address information for reading or programming, and data for programming. The command may be issued as a serial bitstream command packet, where the packet can be logically subdivided into segments of a predetermined size. Each segment can be one byte in size, for example. A bitstream is a sequence or series of bits provided over time. The command is received by the first memory device 24, which compares the device address to its assigned address. If the addresses match, then memory device 24 executes the command. The command is passed through its own output port Xout to the next memory device 26, where the same procedure is repeated. Eventually, the memory device having the matching device address, referred to as a selected memory device, will perform the operation specified by the command. If the command is a read data command, the selected memory device will output the read data through its output port Xout (not shown), which is serially passed through intervening memory devices until it reaches the Xin port of the memory controller 22. Since the commands and data are provided in a serial bitstream, the clock is used by each memory device for clocking in/out the serial bits and for synchronizing internal memory device operations. This clock is used by all the memory devices in the system 20.

Further details of a more specific example of the system 20 of FIG. 1A are provided in FIG. 3A and paragraphs 53-56 of the previously mentioned US patent application publication No. 2008/0201548.

A further performance improvement over the system 20 of FIG. 1A can be obtained by the system of FIG. 1B. System 40 of FIG. 1B is similar to the system 20 of FIG. 1A, except that the clock signal CK is provided serially to each memory device from an alternate memory controller 42 that provides the source synchronous clock signal CK. Each memory device 44, 46, 48 and 50 may receive the source synchronous clock on its clock input port and forward it via its clock output port to the next device in the system. In some examples of the system 40, the clock signal CK is passed from one memory device to another via short signal lines. Therefore, none of the clock performance issues related to the parallel clock distribution scheme are present, and CK can operate at high frequencies. Accordingly, the system 40 can operate with greater speed than the system 20 of FIG. 1A.

Further details of a more specific example of the system 40 of FIG. 1B are provided in FIG. 3B and paragraphs 57-58 of the previously mentioned US patent application publication No. 2008/0201548.

Reference will now be made to FIG. 2. FIG. 2 is a block diagram of a system 200 including a memory controller 210 and a plurality of memory devices 212. The illustrated system may, in many respects, be similar to the system of FIG. 1A, with Xout and Xin ports being diagrammatically illustrated in more granular detail by a plurality of lines, one of which is a status line which extends from device to device around the ring of devices, each of which includes an additional set of IO pins (i.e. additional to the DQ pins) for providing an independent status ring 214. These additional IO pins are labeled SI and SO on the memory controller 210 and each of the memory devices 212. The SI pin and the SO pin are also herein referred to as the status input pin and the status output pin respectively.

Referring now to FIG. 3, there is a block diagram of a system 300, which is similar to the system 200 with the exception that the system 300 employs the serially distributed clock as described in connection with FIG. 1B.

In accordance with the example embodiments of FIGS. 2 and 3, when a memory device 212 or 312 has completed an internal operation such as program, read, erase, etc., it updates its status register with information about the completed operation. Once it has completed updating its status register, the memory device may automatically transmit the contents of its status register over the status ring 214 or 314 back to the controller 210 or 310, thereby notifying the controller 210 or 310 that an outstanding operation has completed. One disadvantage of this arrangement is that many status packets may potentially need to be transmitted over the status ring 214, 314 at times determined by each individual memory device 212, 312, resulting in bus contention.

Other variations on implementing status indication within the systems of FIG. 2 or 3 are contemplated. For example, a simple asynchronous-type implementation is one alternative example embodiment. Any of the memory devices 212 or 312 can, upon the completion of certain internal operations (for example, page read, page program, block erase, operation abort, etc.) issue a single strobe pulse, on the status ring 214 or 314, to notify the controller 210 or 310 of the completion of the operation. The issuance of a single strobe pulse is not, however, necessarily limited to only those instances where some operation has been completed, rather more generally the single strobe pulse is intended to provide an indication of some form of status change within a memory device. Also, it is contemplated that memory devices in accordance with example embodiments may each comprise circuitry for generating strobe pulses, as well as circuitry for outputting strobe pulses.

In at least some asynchronous-type implementations, the status pulse contains no detailed information about the identity of the issuing memory device, so the controller 210 or 310 may learn the identity of the issuing memory device by, for example, broadcasting a Read Status Register command around the ring of devices. Each memory device 212 or 312 in the ring of devices receives the Read Status Register command on its respective CSI pin, processes the command and forwards it to the next downstream memory device which in turn handles the Read Status Register command in a likewise manner. During this process, each of the memory devices 212 or 312 appends it respective status information to a status packet transmitted out on the Q output pins of the memory device. Once the status packet arrives back at the controller 210 or 310, the status packet can be processed to obtain a determination of which memory device has completed an operation and whether that operation was successfully completed (or failed). In some examples, it may be possible for the controller to reduce the bus usage overhead associated with these Read Status Register commands by not always immediately broadcasting a Read Status Register command, but rather waiting until for some number (i.e. number greater than one) of status pulses to be received before broadcasting a Read Status Register command. One disadvantage of this arrangement is that the responses to a broadcast Read Status Register command can potentially occupy a large amount of bandwidth on the data bus, and may result in bus contention with the primary operations of the memory device, such as read and write operations.

Additional complexities arise in an HLNAND ring topology memory system 400 as shown in FIG. 4, having multiple multi-chip packages 404 (“MCPs”), each with multiple NAND dies 414 and at least one bridge chip 412, serially connected to a controller 402 via a channel Xin/Xout which may be subdivided into a plurality of pins as shown in FIGS. 2 and 3. There can be many operations such as read, program, and erase occurring concurrently. Each individual NAND die 414 has a ready/busy pin R/B# (not shown) to indicate progress of the operation in any one die. An HLNAND ring configuration may have more devices than are shown, for example 16 MCPs with 16 NAND dies each for a total of 256 R/B# signals. It is clearly impractical to connect these individually and directly to the controller 402. A further problem is that once an operation has completed as indicated by the R/B# signal, the controller 402 must then read the status register on the NAND die 414 to determine whether the operation completed successfully or whether an error occurred. With many concurrent operations in progress, reading individual status registers over the main HLNAND command/data interface can consume significant bandwidth otherwise available for read and write transactions.

Commonly owned U.S. Patent Application Publication No. 2011/0258366, which is incorporated herein by reference in its entirety, describes several techniques for reading status information from memory devices connected in a ring topology. First, a status signal is provided to each device from the previous device in the ring through an input terminal SI, and each device provides a status signal to the next device on the ring through an output terminal SO. Devices normally pass on the information received on SI to the SO output. When an event occurs within one device such as completion of a read, program or erase operation, the memory device outputs a status packet on SO. The status packet includes a header so that the controller can properly recognize and decode the information, a device identifier, status bits providing information on the completed memory operation, and possibly error correction bits to ensure the correctness of the packet. If an incoming packet is detected from an upstream device in the ring, the local status packet will be held until the incoming packet is complete. This arrangement has the drawback of occupying significant bandwidth on the SI/SO channel, including the possibility of contention and/or delays in delivering status packets to the controller.

A second technique disclosed in U.S. Patent Application Publication No. 2011/0258366 uses the same SI to SO status ring topology. When an event occurs within one device such as completion of a read, program or erase operation, the device adds a one clock cycle duration pulse to SO. If a pulse is received at the same time on SI, the bridge chip extends the pulse to two clock cycles. The controller can observe the total width of pulses received to determine the number of events that occur in a given period of time. To find out exactly which devices and which NAND die triggered the pulses the controller must issue status read commands using the command/data interface. While this arrangement reduces the device-generated bandwidth usage on the SI/SO channel, it has the drawback that the controller cannot identify which device(s) have added the pulse(s) to SI/SO when multiple operations are being performed concurrently. As a result, the controller must issue a broadcast status read command, which consumes significant bandwidth on the command/data interface that could otherwise be used for commands and data.

Therefore, there is a need for a serially connected memory system wherein the controller can obtain ready/busy and status information from the individual memory devices in a fast and efficient manner.

### SUMMARY

It is an object of the present invention to address one or more of the disadvantages of the prior art.

In one aspect, a semiconductor device includes a bridging device having an external data interface, an external status interface, and a plurality of internal data interfaces. A plurality of memory devices are each connected to the bridging device via one of the internal data interfaces. Each of the memory devices has a ready/busy output connected to an input of the bridging device. The bridging device is configured to output a current state of each ready/busy output in a packetized format on the external status interface in response to a status request command received on the external status interface; and read information from a status register of a selected memory device over one of the internal data interfaces and provide the information on the external data interface in response to a status read command received on the external data interface.

In an additional aspect, a method of operating a semiconductor device, the semiconductor device having a bridging device and a plurality of memory devices connected to the bridging device via a plurality of internal data interfaces, includes: receiving a status request command on a status input of the semiconductor device; outputting a current ready/busy state of each memory device in a packetized format on a status output of the semiconductor device in response to the status request command; receiving a status read command on a data input of the semiconductor device; and outputting information from a status register of a selected memory device on a data output of the semiconductor device in response to the status read command.

In a first aspect, a semiconductor device has a bridging device having an external data interface for sending and receiving data and commands, an external status interface for sending and receiving status information, and a plurality of internal data interfaces. A plurality of memory devices are each connected to the bridging device via one of the internal data interfaces. Each of the memory devices has a ready/busy output connected to an input of the bridging device. The bridging device is configured to: output a state of each ready/busy output in a packetized format in response to a status request command; and provide information from a status register of at least one memory device in response to a status read command.

In a further aspect, the state of each ready/busy output is a current state of each ready/busy output.

In a further aspect, the bridging device is configured to output the current state of each ready/busy output on the external status interface.

In a further aspect, the bridging device is configured to output the current state of each ready/busy output in response to a status request command received on the external status interface.

In a further aspect, the bridging device is configured to provide the information from the status register of the at least one memory device on the external data interface.

In a further aspect, the bridging device is configured to read information from a status register of the at least one memory device in response to the status read command.

In a further aspect, the at least one memory device is selected in response to the status read command.

In a further aspect, the at least one memory device is all of the plurality of memory devices.

In a further aspect, a semiconductor memory system has a memory controller; and a plurality of semiconductor devices. The bridging devices of each semiconductor device are serially connected to the controller in a ring topology via the external data interface and the external status interface of each bridging device.

In an additional aspect, a method of operating a semiconductor device, having a bridging device and a plurality of memory devices connected to the bridging device via a plurality of internal data interfaces, includes: outputting a ready/busy state of each memory device in a packetized format; and outputting information from a status register of at least one memory device.

In a further aspect, the ready/busy state of each memory device is a current ready/busy state of each memory device.

In a further aspect, outputting a ready/busy state of each memory device comprises outputting a ready/busy state of each memory device on a status output of the semiconductor device.

In a further aspect, the method includes receiving a status request command on a status input of the semiconductor device. Outputting a ready/busy state of each memory device comprises outputting a ready/busy state of each memory device in response to the status request command received on the external status interface.

In a further aspect, the bridging device is configured to provide the information from the status register of the at least one memory device on the external data interface.

In a further aspect, the method includes receiving a status read command on a data input of the semiconductor device. Outputting information from a status register at least one memory device comprises outputting information from a status register at least one memory device in response to the status read command.

In a further aspect, the method includes selecting the at least one memory device in response to the status read command.

In a further aspect, the at least one memory device is all of the plurality of memory devices.

Additional and/or alternative features, aspects, and advantages of embodiments of the present invention will become apparent from the following description, the accompanying drawings, and the appended claims.

### BRIEF DESCRIPTION OF THE DRAWINGS

FIG. 1A is a block diagram of an example memory system having a parallel clock signal;

FIG. 1B is a block diagram of an example memory system having a source synchronous clock signal;

FIG. 2 is a block diagram of an example memory system having a parallel clock signal, showing additional I/O pins;

FIG. 3 is a block diagram of an example memory system having a source synchronous clock signal, showing additional I/O pins;

FIG. 4 is a block diagram of an alternative memory system having serially-connected multi-chip packages;

FIG. 5 is a block diagram of a memory system according to a first embodiment;

FIG. 6 is a block diagram of a first embodiment of a multi-chip package in the memory system of FIG. 5;

FIG. 7 is a timing diagram of a status request using an addressed status packet;

FIG. 8 is a timing diagram of a status request using a broadcast data packet;

FIG. 9 is a timing diagram of a status request using an addressed status packet with a broadcast address;

FIG. 10 is a timing diagram of a page program operation and status read command;

FIG. 11 is a timing diagram of a block erase operation and status read command;

FIG. 12 is a timing diagram of a page read command; and

FIG. 13 is a block diagram of a second embodiment of a multi-chip package in the memory system of FIG. 5.

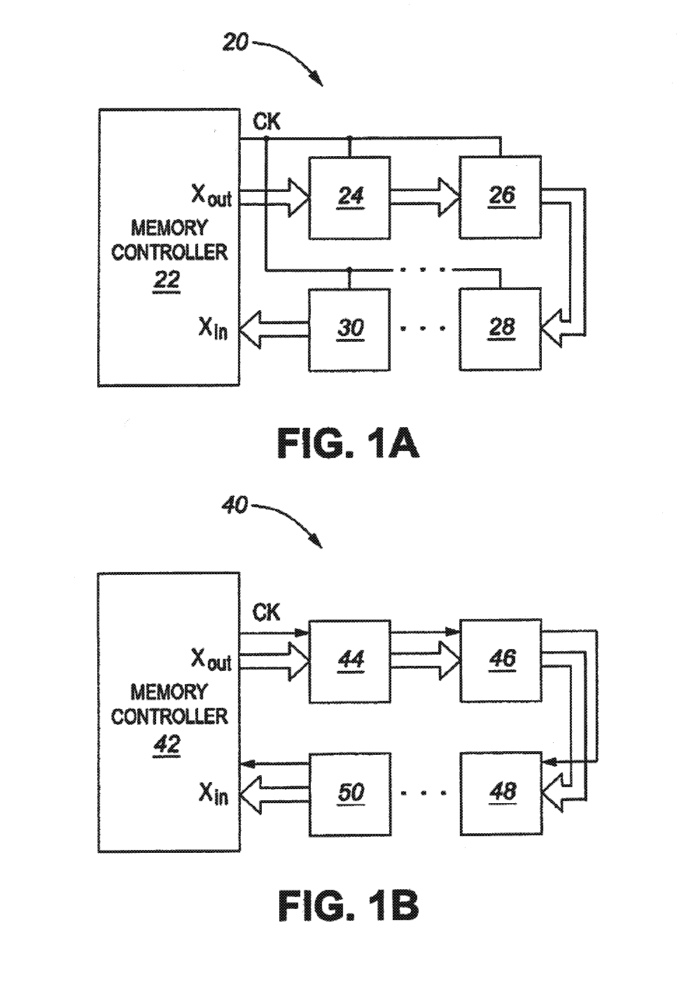

### DETAILED DESCRIPTION

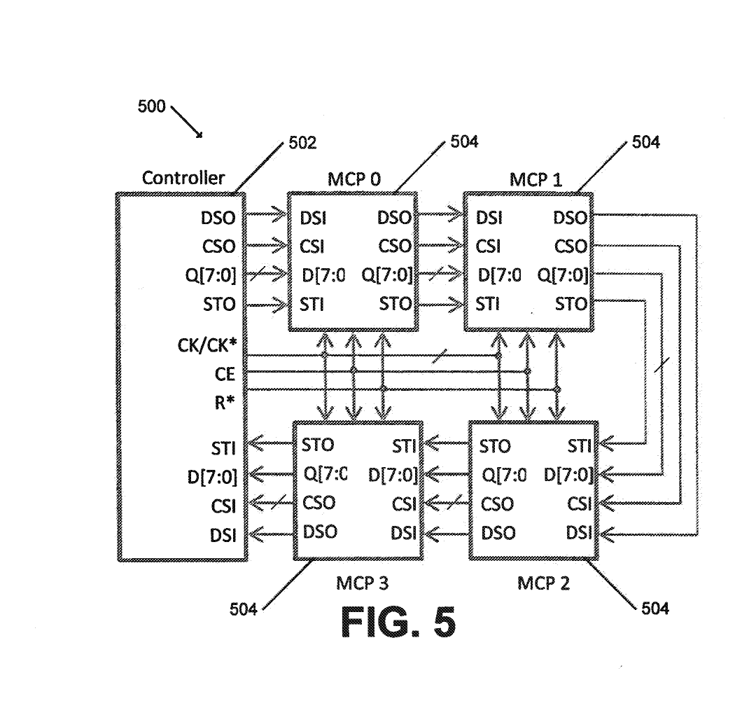

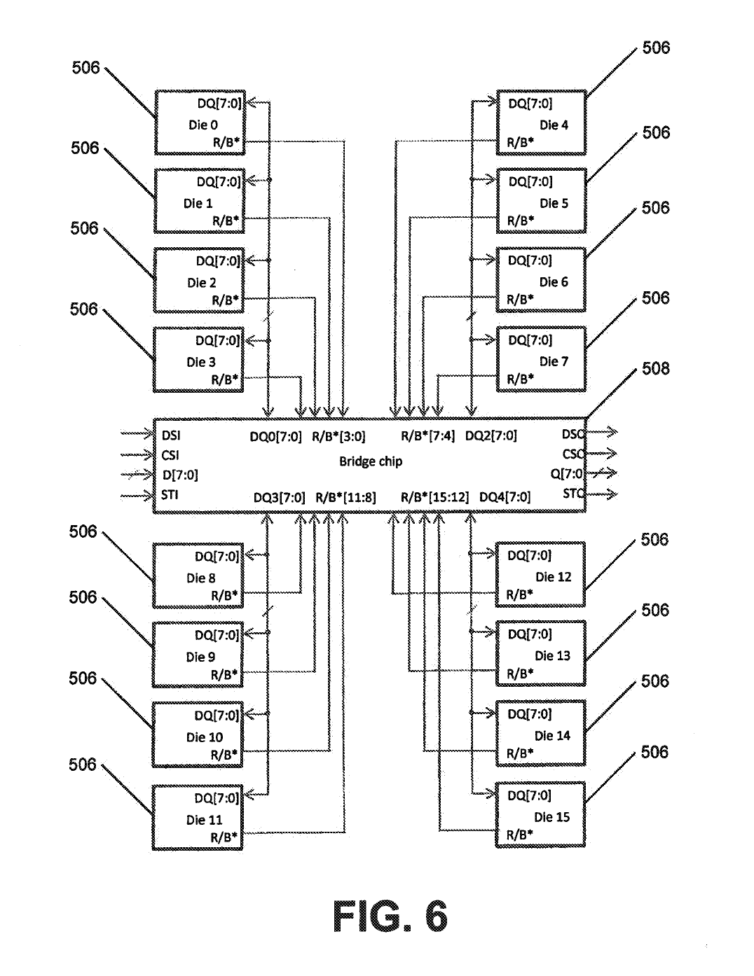

Referring to FIGS. 5 and 6, a memory system 500 includes a controller 502 connected to four multi-chip (MCP) memory devices 504 through a hyperlink (HL) bus forming a point-to-point ring. It is contemplated that more or fewer MCPs 504 could be used. An 8-bit HL data bus D[7:0], Q[7:0] communicates instructions and write data from the controller 502 to the MCPs 504, and read data from the MCPs 504 to the controller 502. A differential clock CK/CK# is provided to all MCPs 504 from the controller 502. While a multi-drop clock architecture is shown in FIG. 5, is contemplated that a serial clock architecture may alternatively be used, wherein each device receives a clock signal from the previous device in the ring. In general, a serial clock architecture is capable of higher-speed operation than a multi-drop clock architecture, due to source synchronous operation and reduced loading on the clock. Each MCP 504 also receives a chip enable signal CE# and a reset signal R# from the controller 502. Point-to-point serial signals CSO/CSI (command strobe) and DSO/DSI (data strobe) identify commands, write data and read data on the Q[7:0]/D[7:0] bus. Status information is provided on the STO/STI ring, in a manner that will be discussed below in further detail.

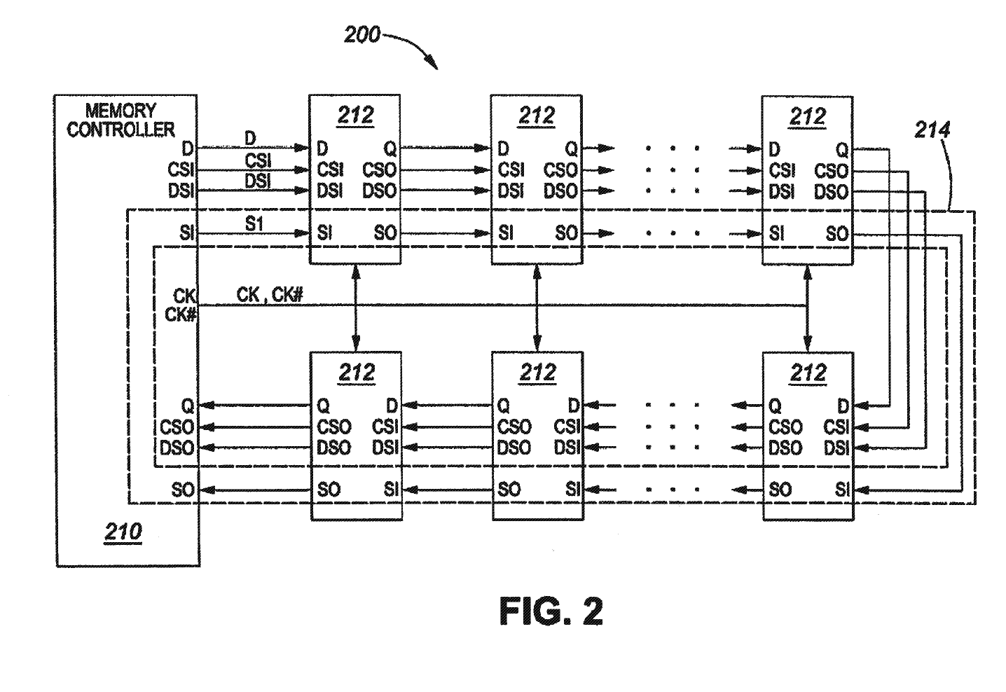

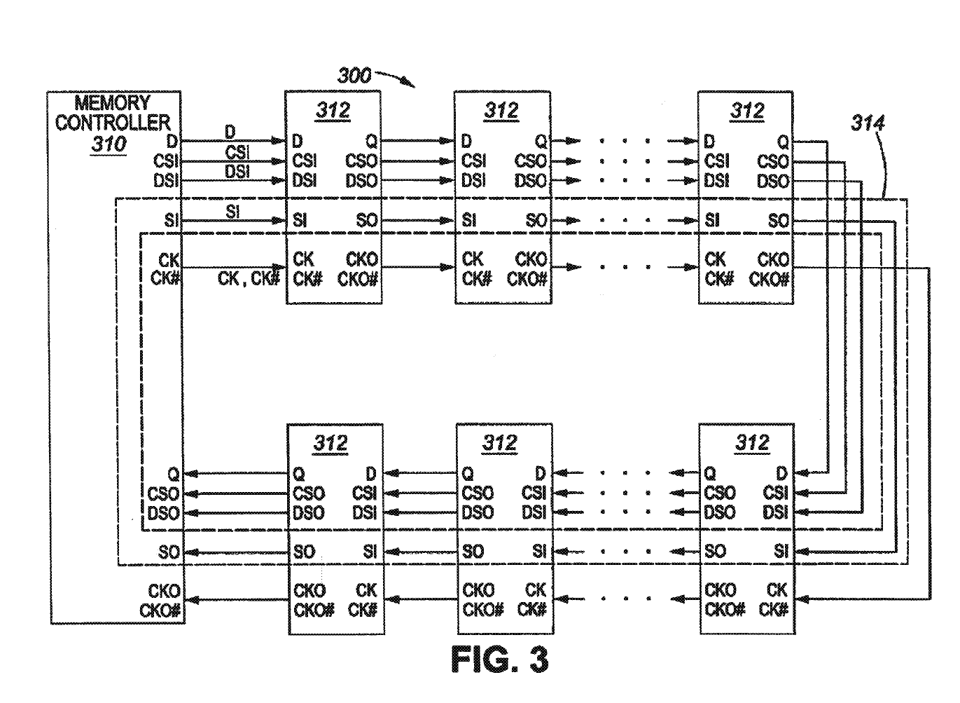

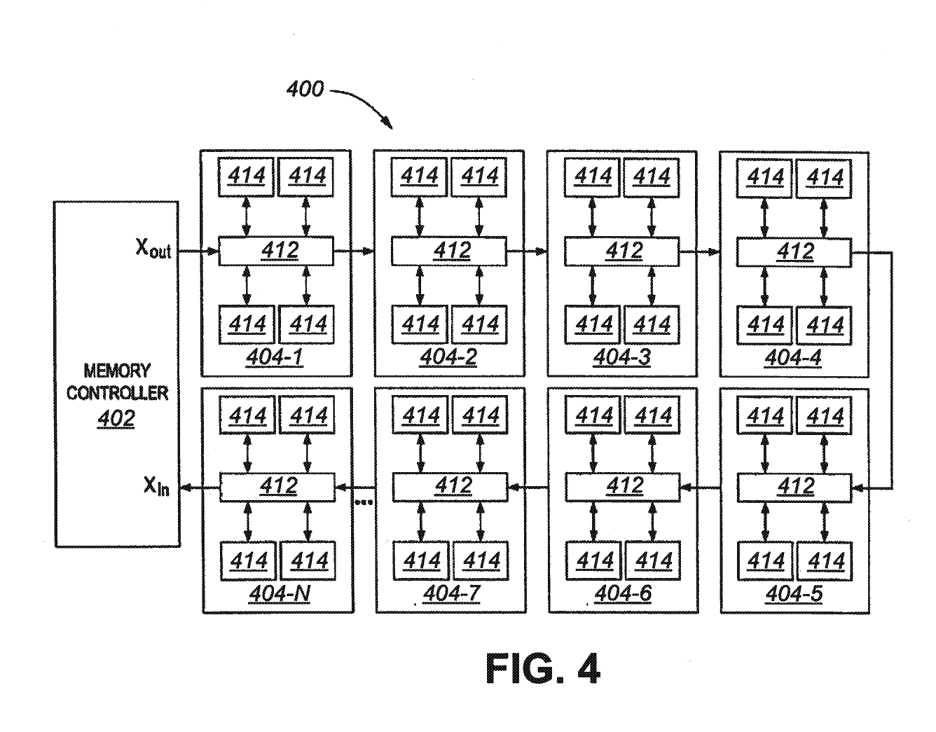

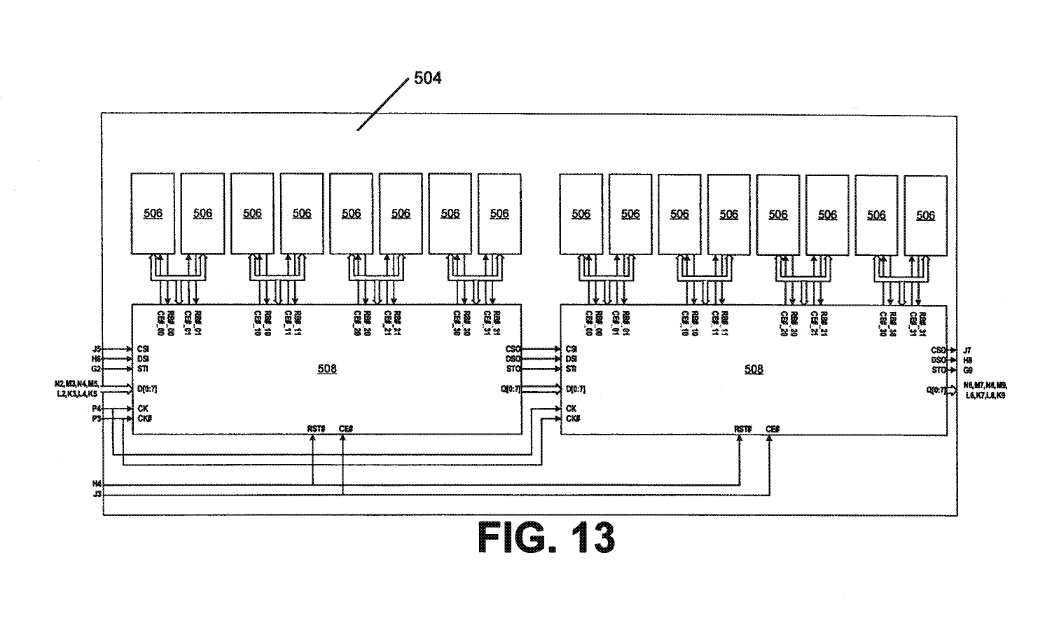

Referring to FIG. 6, each MCP 504 contains 16 memory dies 506. The dies 506 are NAND flash memory dies, but it is contemplated that any other suitable type of memory die may be used, for example NOR flash or DRAM. A bridge chip 508 is a bridging device that provides an internal interface to communicate with the dies 506 in their native protocol, which may for example be asynchronous NAND, toggle mode NAND, or ONFI. The MCP 504 could alternatively contain fewer or more than 16 dies 506, or fewer or more than four internal channels. Referring to FIG. 13, the MCP 504 may alternatively contain more than one serially connected bridge chip 508, and may have two dies 506 per internal channel. Referring again to FIG. 6, the internal interface connecting each die 506 to the bridge chip 508 includes a parallel data bus DQ[7:0], a ready/busy pin R/B#, and other pins (not shown) which may include individual chip enable pins CE#, command and data strobes, and a differential clock signal. It should be understood that different protocols will necessitate different signal connections. For example, asynchronous NAND typically includes ALE, CLE, WE#, and WP# signals in the internal interface. Synchronous NAND, such as ONFI or toggle mode, may have different and additional signals. For example, ONFI NAND does not require a WE# signal but typically includes CLK and DQS signals. All of the signals required to provide a functional interface should be known and understood by persons of skill in the art. It is contemplated that the dies 506 that share each internal channel may alternatively be connected to the bridge chip 508 via a serial interface including a point-to-point data bus, similarly to how the dies 212, 312 of FIGS. 2 and 3 are serially connected to the controller 210, 310. The dies 506 also require power connections such as Vcc, Vss, Vccq, Vref, and Vpp, which may be provided directly from pins of the MCP 504.

Referring still to FIG. 6, each die 506 communicates a change in its status to the bridge chip 508 via its R/B# pin. The bridge chip 508 may then read the status register on the die 506 via a status read command to determine additional information, such as whether a completed operation was successfully completed (pass) or resulted in an error (fail). The status read command is communicated over the internal interface DQ between the bridge chip 508 and the die 506. The internal interface DQ is shared with other dies 506 that may be using the interface for other operations, such as instructions or data transfer. Contention can be managed by using the bridge chip 508 to schedule the status read commands between other operations. The bridge chip 508 issues status read commands and outputs status information on the STO pin at the request of the controller 502, in a manner that will be discussed below in further detail.

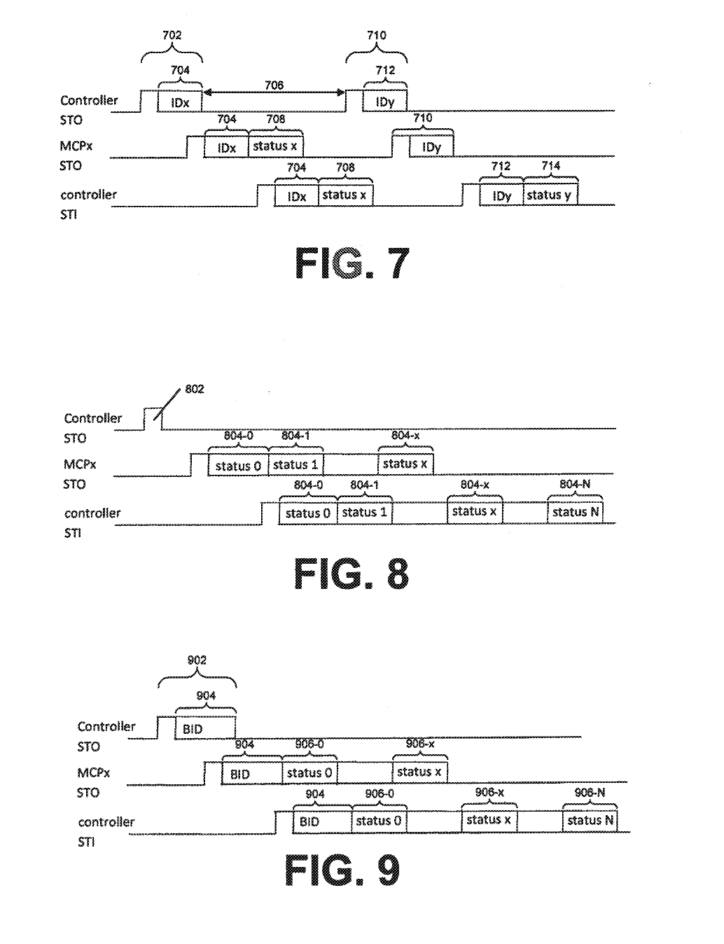

Referring to FIG. 7, one method of performing a status request by the controller 502 uses an addressed status packet 702 on STO. The controller first requests the status of MCP x by indicating the start of a status packet with two flag bits having logic level ‘1’ followed by the device ID byte 704 for MCP x. The start of the status packet may alternatively be indicated by eight ‘1’s in a byte oriented protocol, or by any other bit pattern that is distinguishable from the idle state, in this example continuous ‘0’s. After a device detects the start flag, it will not recognize another start flag for a time period at least as long as the maximum status packet length.

The controller ensures that there is a sufficient space 706 for MCP x to insert status information 708 before the next status packet 710. When MCP x receives the blank status packet 702, the MCP x recognizes the device ID byte and inserts the local status information 710 onto the STO stream in a manner that will be described below in further detail. MCP x passes the status packet 710 to its output unaltered, because the status packet 710 is addressed to MCP y. Likewise, when MCP y further downstream recognizes the device ID byte 712 in the subsequent status packet 710, MCP y will insert its own status information 714. In this diagram the clocks are not shown for simplicity. Each device in the ring will delay the status information by approximately one clock cycle. The controller may implement continuous sequential polling of all devices in the system. Alternatively, the controller may send a status request addressed to a particular device only when a change in the status of that device is expected, for example after a read, program, or erase command is sent to that device. Sending status requests only when a status change is expected reduces power consumption, but requires some additional controller complexity.

Referring to FIG. 8, a status request may alternatively be performed by the controller 502 using a broadcast status packet 802, which is a single status request to which all of the devices respond. The controller 502 indicates the start of a status packet with the appropriate flag bits to distinguish the request from the idle state of STI/STO. Here, no device address is required because all devices will respond to the command. The controller 502 leaves a sufficient space between consecutive packets to allow for all of the devices to append their status information, based on the number of devices in the ring. It should be understood that it is possible for the controller 502 to issue broadcast status read commands on the STO/STI link more frequently if there are fewer devices in the ring. Each MCP 504 in the ring appends its local status information 804 to the status packet 802 in a manner that will be described below in further detail, leaving an appropriate offset to allow for the status information 804 appended by upstream devices in the ring. The offset can be calculated by each device based on its local ID and the known fixed length of the status information from each MCP 504. The status packet 806 received by the controller 502 on STI contains status information about all of the MCPs 504 in the ring.

Referring to FIG. 9, a status request may alternatively be performed by the controller 502 using an addressed status read packet 902 similar to the embodiment of FIG. 7 but having a device ID field 904 corresponding to a broadcast device ID (“BID”), for example “11111111”. Each MCP 504 recognizes the BID and appends its local status information 906 to the status packet 902 in a manner similar to that of the embodiment of FIG. 8. The general technique of an addressed packet with a special address for broadcast is described in commonly owned U.S. Patent Application Publication No. 2010/0162053, the contents of which are hereby incorporated by reference in their entirety.

Each MCP 504 outputs its local status information in response to status requests in a format that allows the controller 502 to determine the R/B# status of all of the dies 506 in the system. One example format is shown in the table below, for a 16-die MCP 504 having four internal data interfaces. The first 16 bits R/B#[n] each represent the logic level of the R/B# signal from the nth die in the MCP 504, the next four bits DQBn each represent the current state of the nth internal data interface (1=busy, 0=inactive). The final bit is a command packet error (CPE) bit (1=error, 0=no error), and the remaining bits may be used for other purposes or ignored by the controller 502. It should be understood that other formats may be used, and that the format may be modified based on the number of status bits (R/B# pins and/or internal data interfaces) to be communicated to the controller 502.

| byte | bit 0 | bit 1 | bit 2 | bit 3 | bit 4 | bit 5 | bit 6 | bit 7 |
|---|---|---|---|---|---|---|---|---|
| 1 | R/B#[0] | R/B#[1] | R/B#[2] | R/B#[3] | R/B#[4] | R/B#[5] | R/B#[6] | R/B#[7] |
| 2 | R/B#[8] | R/B#[9] | R/B#[10] | R/B#[11] | R/B#[12] | R/B#[13] | R/B#[14] | R/B#[15] |
| 3 | DQB0 | DQB1 | DQB2 | DQB3 | | | | CPE |

These status bits enable the controller 502 to track the progress of commands issued on the HL interface based only on information already available to the bridge chip 508, and therefore without using any bandwidth on the internal interface of the MCPs 504. The R/B# and data interface status bits are indicative of the current status of the operations performed at the various dies 506 as will be described in further detail below. If the controller 502 requires more detailed status information about one or more dies 506, such as whether an operation has completed successfully, the controller 502 may send a status read command on the HL data bus addressed to one or more dies 506 or MCPs 504. In response to the status read command, the associated bridge chip 508 requests the status of the addressed die 506 via the internal interface of the MCP 500, and returns the status information to the controller 502.

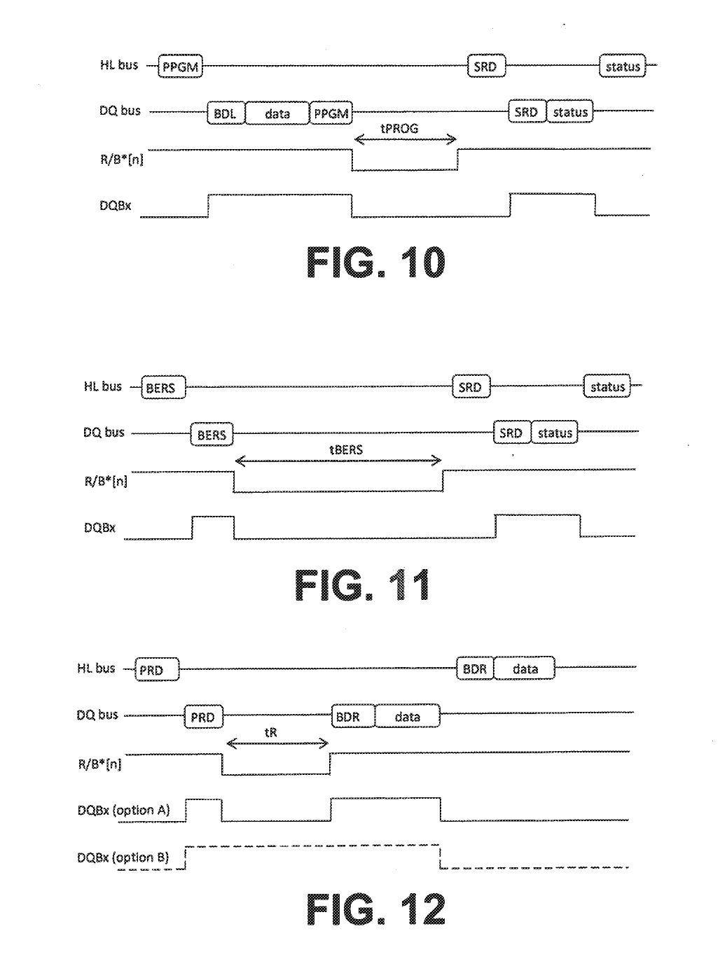

Referring to FIG. 10, a timing diagram for a Page Program (write) command (PPGM) is shown. Some of the signals, such as the command/data strobes and the clock, are omitted for clarity. The PPGM command is sent by the controller 502 over the HL bus and received by the MCP 504. Write data previously stored in SRAM on the bridge chip 508 via a burst data load command (not shown) is transferred to the page buffer of the appropriate die 506 over the internal DQ bus of the MCP 504 with a Burst Data Load (BDL) command. While the internal DQ bus is in use, the corresponding DQB status bit is logic high to reflect the bus activity. After the data has been transferred, the bridge chip 508 initiates a Page Program operation on the die 506, which will be indicated as busy on the appropriate R/B# status bit for the duration of the Page Program operation tPROG. The controller 502 can monitor the progress of the operation by issuing status request commands which return the R/B# status of the die 506. The controller 502 may optionally wait for the specified maximum duration of tPROG before issuing status request commands addressed to the die 506, to reduce bandwidth usage on the ST bus. Once the programming is complete, as indicated by the R/B# status of the die 506, the controller 502 can check the pass/fail status of the operation by issuing a Status Read (SRD) command addressed to the same die 506. The bridge chip 508 initiates a Status Read Command on the internal DQ bus and obtains the status information to return to the controller 502 on the HL interface.

Reading the status register of the die 506 requires use of the internal interface between the bridge chip 508 and the die 506. If another die 506 sharing the same internal interface is exchanging instructions or data with the bridge chip 508, there will be contention. To minimize contention for the internal interface between die operations and status read operations, the bridge chip 508 first provides to the controller 502 the status information that can be determined solely by the internal state of the bridge chip 508 and the R/B# signals from the individual dies 506. The controller 502 may then request additional status information from specified dies 506 through status read commands. These status read commands will use the internal interface, but they will be fewer in number, and the bridge chip 508 can schedule these commands among other commands and data transactions to avoid contention.

Referring to FIG. 11, a timing diagram for a Block Erase command (BERS) is shown. Some of the signals, such as the command/data strobes and the clock, are omitted for clarity. The BERS command is sent by the controller 502 over the HL bus and received by the MCP 504. Unlike the PPGM command of FIG. 10, the BERS command is not accompanied by data. The BERS command is transferred to the appropriate die 506 over the internal DQ bus of the MCP 504. While the internal DQ bus is in use, the DQB status bit is logic high to reflect the bus activity. The die 506 then initiates a block erase command, for the duration of which (tBERS) the die 506 will be indicated as busy on the appropriate R/B# status bit. While the die 506 is internally carrying out the Block Erase command, the DQB status bit transitions to logic low to indicate that the internal DQ bus is available for the bridge chip 508 to send instructions to other dies 506 on the same internal channel. Once the block erase is complete, as indicated by the R/B# status of the die 506, the controller 502 can check the pass/fail status of the operation by issuing a Status Read (SRD) command addressed to the same die 506. The bridge chip 508 initiates a Status Read Command on the internal DQ bus and obtains the status information to return to the controller 502 on the HL interface.

Referring to FIG. 12, a timing diagram for a Page Read command (PRD) is shown. Some of the signals, such as the command/data strobes and the clock, are omitted for clarity. The PRD command is sent by the controller 502 over the HL bus and received by the MCP 504. The PRD command is transferred to the appropriate die 506 over the internal DQ bus of the MCP 504. The bridge chip 508 waits for a time tR to allow the internal read operation on the die 506 to be completed, which is indicated by a change in the R/B# status of the die 506. The bridge chip 508 then issues a Burst Data Read command (BDR) on the DQ bus. The die 506 then transfers the requested data to the bridge chip 508 over the DQ bus, to be stored on the SRAM of the bridge chip 508. While the DQ bus is in use, the DQB status bit is logic high to reflect the bus activity. The bridge chip 508 then transmits the data to the controller 502 over the HL bus. The controller 502 does not need to issue a Status Read Command, because the controller 502 will receive the requested data once the operation is successfully completed.

Referring still to FIG. 12, during the time tR, which may be on the order of 100 μs, the DQ interface is not in use, and is available to perform operations directed to other dies 506 on the same internal DQ interface (option A). If the bridge chip 508 receives an instruction addressed to one of the other dies 506 n the same DQ interface before R/B#[n] goes high (indicating the availability of the read data), the instruction can be initiated. If the operation is not complete by the time R/B#[n] goes high, the Burst Data Read to transfer data to the bridge chip SRAM will be delayed. If the bridge chip 508 receives the instruction after R/B#[n] goes high, the Burst Data Read operation will be completed before the new instruction is initiated. This approach allows use of the internal DQ bus during the tR interval at the expense of some uncertainty in when the DQ bus will be available to carry out a subsequent instruction. As an alternative (option B), subsequent instructions can be prohibited until the internal BDR is complete by considering the DQ bus “in use” during tR, in which case the DQBx signal can be asserted for the entire period. This simplifies scheduling and provides more deterministic operation of the MCP 504.

It should be understood that the bridge chip 508 provides status information to the controller 502 at the request of the controller 502, and not asynchronously in response to events that occur within the MCP 500. In this manner, contention is eliminated on the STI/STO bus and managed by the controller 502 on the HL data bus, for example if two events occur simultaneously in two different MCPs 500. In addition, the present method creates uniform timing from status requests by the controller 502 to receipt of the requested status information by the controller 502. In addition, the controller 502 can request status information only when it is required, which may be less frequently than every time an operation is completed.

Modifications and improvements to the above-described embodiments of the present invention may become apparent to those skilled in the art. The foregoing description is intended to be by way of example rather than limiting. The scope of the present invention is therefore intended to be limited solely by the scope of the appended claims.

1. A semiconductor device comprising:
a bridging device having an external data interface for sending and receiving data and commands, an external status interface for sending and receiving status information, and a plurality of internal data interfaces; and
a plurality of memory devices each connected to the bridging device via one of the internal data interfaces, each of the memory devices having a ready/busy output connected to an input of the bridging device,
the bridging device being configured to:
output a state of each ready/busy output in a packetized format in response to a status request command; and
provide information from a status register of at least one memory device in response to a status read command.

2. The semiconductor device of claim 1, wherein:
the state of each ready/busy output is a current state of each ready/busy output.

3. The semiconductor device of claim 2, wherein:
the bridging device is configured to output the current state of each ready/busy output on the external status interface.

4. The semiconductor device of claim 2, wherein:
the bridging device is configured to output the current state of each ready/busy output in response to a status request command received on the external status interface.

5. The semiconductor device of claim 1, wherein:
the bridging device is configured to provide the information from the status register of the at least one memory device on the external data interface.

6. The semiconductor device of claim 5, wherein:
the bridging device is configured to read information from a status register of the at least one memory device in response to the status read command.

7. The semiconductor device of claim 5, wherein:
the at least one memory device is selected in response to the status read command.

8. The semiconductor device of claim 5, wherein:
the at least one memory device is all of the plurality of memory devices.

9. A semiconductor memory system comprising:
a memory controller; and
a plurality of semiconductor devices according to claim 1, the bridging devices of each semiconductor device being serially connected to the controller in a ring topology via the external data interface and the external status interface of each bridging device.

10. A method of operating a semiconductor device, the semiconductor device having a bridging device and a plurality of memory devices connected to the bridging device via a plurality of internal data interfaces, the method comprising:
outputting a ready/busy state of each memory device in a packetized format; and
outputting information from a status register of at least one memory device.

11. The method of claim 10, wherein:
the ready/busy state of each memory device is a current ready/busy state of each memory device.

12. The method of claim 11, wherein:
outputting a ready/busy state of each memory device comprises outputting a ready/busy state of each memory device on a status output of the semiconductor device.

13. The method of claim 11, further comprising:
receiving a status request command on a status input of the semiconductor device,
wherein:
outputting a ready/busy state of each memory device comprises outputting a ready/busy state of each memory device in response to the status request command received on the external status interface.

14. The method of claim 10, wherein:
the bridging device is configured to provide the information from the status register of the at least one memory device on the external data interface.

15. The method of claim 14, further comprising:
receiving a status read command on a data input of the semiconductor device,
wherein:
outputting information from a status register at least one memory device comprises outputting information from a status register at least one memory device in response to the status read command.

16. The method of claim 15, further comprising:
selecting the at least one memory device in response to the status read command.

17. The method of claim 15, wherein:
the at least one memory device is all of the plurality of memory devices.
